(19) United States
(12) Patent Application Publication
(10) Pub. No.: US 2008/0153070 A1
(43) Pub. Date: Jun. 26, 2008

(54) SPATIALLY SEPARATED SPEECH-IN-NOISE AND LOCALIZATION TRAINING SYSTEM

(76) Inventors: Richard S. Tyler, West Liberty, IA (US); Camille Dunn, Tipton, IA (US); Shelley Witt, Wheatland, IA (US); Wenjun Wang, Coralville, IA (US)

Correspondence Address: NEEDLE & ROSENBERG, P.C., SUITE 1000, 999 PEACHTREE STREET, ATLANTA, GA, 30309-3915, US

(21) Appl. No.: 11/613,381

(22) Filed: Dec. 20, 2006

(51) Int. Cl. G09B 9/00

(52) U.S. Cl. 434/1; 434/118

(57) ABSTRACT

Provided are training methods and training systems that allow for spatially separated speech-in-noise and localization training. The methods and systems can provide spatial distinctness through the use of stimuli from multiple spatial locations. The methods and systems allow for training a student to segregate sound, localize, track sound, suppress information from one source to focus on another, and judge both movement and distance.

### BACKGROUND

Since the 1940s, hearing researchers have used multiple loudspeakers to test spatial hearing abilities. Interest has included the perception of sound coming from different locations and the benefit of two ears. Thus, work has focused on measuring the potential advantage of two ears over one ear, or over measuring the limits of our ability to discriminate sounds coming from different locations. All of these studies have been focused on testing hearing abilities or on measuring the effects of devices.

Most of this work has focused on normal listeners, but interest in measuring the spatial hearing abilities of hearing impaired people has increased in the last 10 years. This research is interested in the effects of hearing loss and the influence of using two hearing aids, two cochlear implants, or combinations of them. This research has used from 2 to +100 loudspeakers. Recently, work has also included virtual sound reality under earphones.

All of these studies have been focused on testing hearing abilities or on measuring the effects of devices. None have attempted to improve spatial hearing by training.

Most people with hearing loss, even those well fit with hearing devices, still experience significant problems understanding speech-in-noise. Because nearly all hearing-impaired people have difficulty hearing in noise, the potential audience for this type of system is enormous. Approximately 31 million Americans and 500 million individuals world-wide suffer from hearing loss. According to the National Institute of Deafness and Other Communication Disorders, hearing loss is one of the most prevalent chronic health conditions. It affects people of all ages and across all socioeconomic levels. Aging is one of the primary causes of hearing loss. As the population ages and more “baby boomers” reach retirement age, the market for this product will be stable and ever increasing.

The most common complaint of individuals with hearing loss, even those who wear hearing aids or cochlear implants, is listening and understanding in noise. To effectively listen in noise, individuals must be able to spatially segregate, localize, track sound, suppress information from one source to focus on another, and judge both movement and distance. None of this can be done by simply wearing a hearing device. Laboratory studies have demonstrated that at least some individuals with hearing loss can experience improved speech understanding with training. However, previous training systems that have at least one basic, critical limitation. They ignore the fundamental cues normally used to separate speech and noise.

The ability to localize and understand speech-in-noise is influenced by spatial separation. Spatial separation of sound allows our auditory system to naturally ignore and “squelch” unnecessary sound.

Current auditory training systems ignore the fundamental cues normally used to hear speech-in-noise, and no training system has been designed to teach localization. In addition, their stimuli source is usually limited to a single loudspeaker or present the same stimulus to two loudspeakers or two earphones.

### SUMMARY

Provided are training methods and training systems that allow for spatially separated speech-in-noise and localization training. The methods and systems can provide spatial distinctness through the use of stimuli from multiple spatial locations. The methods and systems allow for training a student to segregate sound, localize, track sound, suppress information from one source to focus on another, and judge both movement and distance.

The methods and systems enable people to improve their hearing in noise and to improve their localization skills. The methods and systems can utilize spatially separate stimuli that originate from different spatial locations (either physically or virtually). The methods and systems can utilize both speech perception and localization tasks. The methods and systems can utilize a variety of hardware and software options to implement the system (including, but not limited to, multiple physical loudspeakers, earphones, virtual reality, connections to hearing aids, cochlear implants and assistive listening devices).

The methods and systems can be computer implemented. Stimuli from different locations can be presented, feedback can be provided, and the level of difficulty can be controlled to facilitate improvement. The methods and systems can comprise several training modules to meet the listening needs of students.

Most people have some hearing difficulties, particularly understanding speech-in-noise and determining the precise direction of sounds. Individuals who can benefit from the methods and systems include hearing impaired individuals (with or without hearing aids, cochlear implants or assistive listening devices), normal hearing individuals who wish to improve hearing in noise and localization, individuals who have difficulty hearing accented speech, and people with auditory processing disorders and central auditory dysfunction. It also is applicable to individuals who wish to improve their listening skills, including the military and transportation employees (e.g. ship and airplane pilots).

Additional embodiments and aspects of the methods and systems will be set forth in part in the description which follows or may be learned by practice of the methods and systems. The embodiments and aspects will be realized and attained by means of the elements and combinations particularly pointed out in the appended claims. It is to be understood that both the foregoing general description and the following detailed description are exemplary and explanatory only and are not restrictive of the methods and systems, as claimed.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is an exemplary operating environment;

FIG. 2 is an exemplary audio output system;

FIG. 3 provides a schematic of spatial separation of speech stimuli (e.g. a word) and noise;

FIG. 4 illustrates stimuli 401-408 as presented from different spatial locations 201-208 relative to a student 409;

FIG. 5 illustrates an exemplary visual display;

FIG. 6 is an exemplary training method;

FIG. 7 is an exemplary training program;

FIG. 8 is an exemplary training program;

FIG. 9 a bilateral CI patient's daily log of practice time utilizing the methods and systems;

FIG. 10 shows general speech perception data collected over time and pre- and post-training for words in quiet (Consonant-Nucleus-Consonant or CNC Words) and sentences in noise;

FIG. 11 illustrates results from an adaptive spondee in noise test;

FIG. 12 illustrates overtime and post-training localization performance collected from the same bilateral CI patient as shown in FIGS. 9-11.

### DETAILED DESCRIPTION

Before the present methods and systems are disclosed and described, it is to be understood that the methods and systems are not limited to specific methods or to specific components, as such may, of course, vary. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not. “User,” “student,” and “listener” refer to a human or other animal that is utilizing the methods and systems described herein for training.

The present methods and systems may be understood more readily by reference to the following detailed description of preferred embodiments and the Examples included therein and to the Figures and their previous and following description.

### I. TRAINING SYSTEM

In an exemplary embodiment, provided is a system for improving hearing in noise and localization comprising a plurality of spatial locations configured to originate a stimulus, a memory, configured for storing a plurality of stimuli, and a processor, coupled to the memory and the plurality of spatial locations, configured for performing the steps of (a) providing at least one stimulus having one of a plurality of stimulus content, wherein said stimulus originates from at least one of a plurality of spatial locations to a student, (b) receiving a judgment of the one of a plurality of stimulus content, the stimulus spatial location, or both, of said stimulus from the student, (c) providing feedback to the student regarding the correctness of the judgment, and (d) repeating steps a, b, and c, varying the at least one stimulus content or the at least one of the plurality of spatial locations, wherein the student learns cues to determine the correct stimulus content, the correct stimulus spatial location, or both. More than one stimulus can be provided sequentially or simultaneously.

Examples of stimulus content include, but are not limited to, speech, noise, a sound effect, a tone, and music. Examples of hardware that can provide stimuli from spatial locations include, but are not limited to, loudspeakers, headphones, headphones configured to virtually simulate a plurality of spatial locations (i.e., head related transfer functions, either average or based on the individual student), hearing aids, cochlear implants, assistive listening devices, and the like. If the system is utilizing headphones or use direct input to train with a virtual reality spatial distinct space, then the system can be based on either average head related transfer functions or (with additional effort), the users individual head related transfer function.

The step of providing at least one stimulus can further comprise receiving a spatial location selection from which to provide the at least one stimulus.

The step of providing at least one stimulus can further comprise providing the at least one stimulus from a randomly selected spatial location. Repeating steps a, b, and c can further comprise providing the at least one stimulus from a spatial location a predetermined number of spatial locations from the randomly selected spatial location. Repeating steps a, b, and c can still further comprise adjusting the predetermined number of spatial locations wherein the predetermined number is increased if the student judgment is incorrect and the predetermined number is decreased if the student judgment is correct.

The system can further comprise a first stimulus content and a second stimulus content wherein the first stimulus content comprises speech content and the second stimulus content comprises noise content.

In one aspect, the methods and systems can comprise a laptop computer, eight small loudspeakers, and a plurality of training modules. For example, the methods and systems can comprise four speech-in-noise training modules and two localization training modules.

The training modules can range from easy to difficult, and can use different learning approaches to suit individual needs. Feedback and reinforcement can be provided. Students can select a training module and can enter and exit the training modules at any time. There are several options that can be provided to a student utilizing the training modules. These options include:
students can make activities shorter or longer in duration and harder or easier in difficulty
students can choose how many times they want a sound repeated
students can usually choose the loudspeakers which contain the target stimuli and background noise.

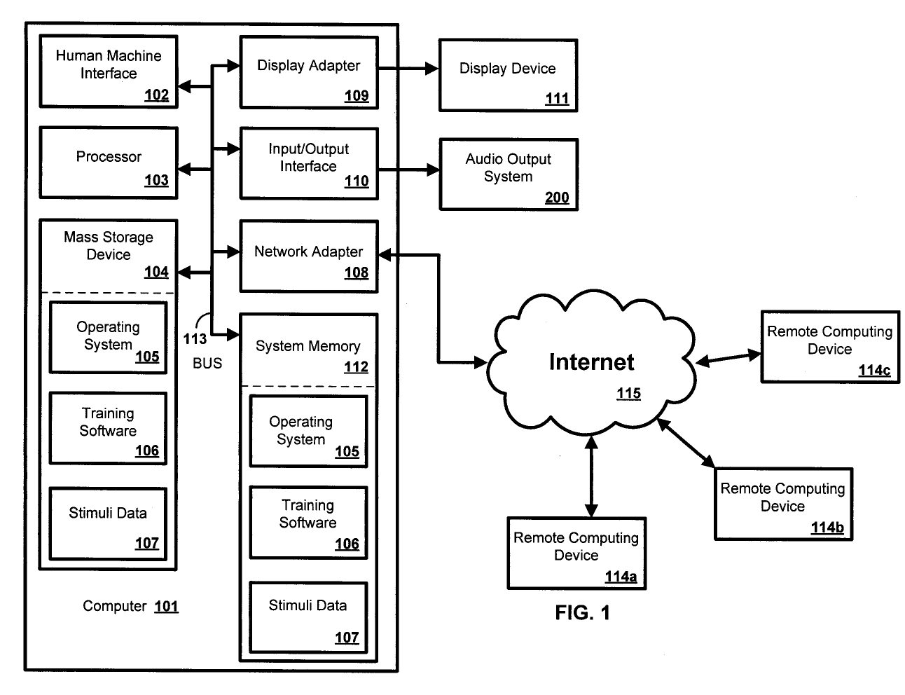

One skilled in the art will appreciate that the descriptions provided herein are functional descriptions and that the respective functions can be performed by software, hardware, or a combination of software and hardware. The methods and systems can comprise the training software 106 as illustrated in FIG. 1 and described below. In one exemplary aspect, the methods and systems can comprise a computer 101 as illustrated in FIG. 1 and described below.

FIG. 1 is a block diagram illustrating an exemplary operating environment for performing the disclosed methods. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The methods and systems can be operational with numerous other general purpose or special purpose computing system environments or configurations. Examples of well known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

In another aspect, the methods and systems can be described in the general context of computer instructions, such as program modules, being executed by a computer. Generally, program modules comprise routines, programs, objects, components, data structures, etc. that perform particular tasks or implement particular abstract data types. The methods and systems can also be practiced in distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a general-purpose computing device in the form of a computer 101. The components of the computer 101 can comprise, but are not limited to, one or more processors or processing units 103, a system memory 112, and a system bus 113 that couples various system components including the processor 103 to the system memory 112.

The system bus 113 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI) bus also known as a Mezzanine bus. The bus 113, and all buses specified in this description can also be implemented over a wired or wireless network connection and each of the subsystems, including the processor 103, a mass storage device 104, an operating system 105, training software 106, stimuli data 107, a network adapter 108, system memory 112, an Input/Output Interface 110, a display adapter 109, a display device 111, and a human machine interface 102, can be contained within one or more remote computing devices 114a,b,c at physically separate locations, connected through buses of this form, in effect implementing a fully distributed system.

The computer 101 typically comprises a variety of computer readable media. Exemplary readable media can be any available media that is accessible by the computer 101 and comprises, for example and not meant to be limiting, both volatile and non-volatile media, removable and non-removable media. The system memory 112 comprises computer readable media in the form of volatile memory, such as random access memory (RAM), and/or non-volatile memory, such as read only memory (ROM). The system memory 112 typically contains data such as stimuli data 107 and/or program modules such as operating system 105 and training software 106 that are immediately accessible to and/or are presently operated on by the processing unit 103.

In another aspect, the computer 101 can also comprise other removable/non-removable, volatile/non-volatile computer storage media. By way of example, FIG. 1 illustrates a mass storage device 104 which can provide non-volatile storage of computer code, computer readable instructions, data structures, program modules, and other data for the computer 101. For example and not meant to be limiting, a mass storage device 104 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 104, including by way of example, an operating system 105 and training software 106. Each of the operating system 105 and training software 106 (or some combination thereof) can comprise elements of the programming and the training software 106. Stimuli data 107 can also be stored on the mass storage device 104. Stimuli data 107 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems.

In another aspect, the user can enter commands and information into the computer 101 via an input device (not shown). Examples of such input devices comprise, but are not limited to, a keyboard, pointing device (e.g., a “mouse”), a microphone, a joystick, a scanner, and the like. These and other input devices can be connected to the processing unit 103 via a human machine interface 102 that is coupled to the system bus 113, but can be connected by other interface and bus structures, such as a parallel port, game port, an IEEE 1394 Port (also known as a Firewire port), a serial port, or a universal serial bus (USB).

In yet another aspect of the present methods and systems, a display device 111 can also be connected to the system bus 113 via an interface, such as a display adapter 109. It is contemplated that the computer 101 can have more than one display adapter 109 and the computer 101 can have more than one display device 111. For example, a display device can be a monitor, an LCD (Liquid Crystal Display), or a projector. In addition to the display device 111, other output peripheral devices can comprise components such as audio output system 200 which can be connected to the computer 101 via Input/Output Interface 110.

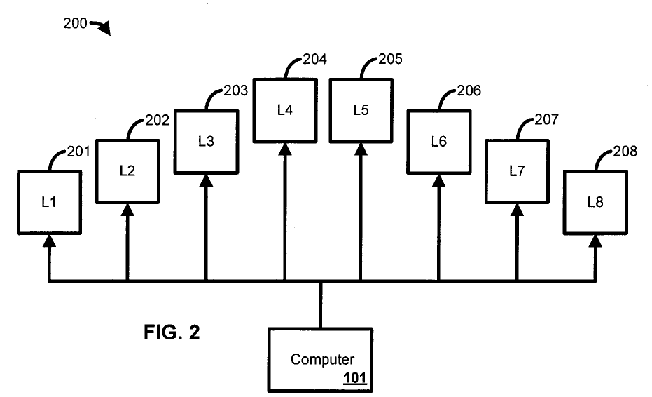

Audio output system 200 is further illustrated in FIG. 2. Audio output system 200 can comprise one or more sound sources (L1-L8) 201-208 positioned in different spatial locations. For example, the system can use two or more sound sources. Examples of sound sources include, but are not limited to, loudspeakers, headphones, headphones configured to virtually simulate a plurality of spatial locations (i.e., head related transfer functions, either average or based on the individual student), hearing aids, cochlear implants, assistive listening devices, and the like. In one aspect, stimuli can be streamed over the Internet 115 to the computer 101 for play over the sound sources 201-208.

The computer 101 can operate in a networked environment using logical connections to one or more remote computing devices 114a,b,c. By way of example, a remote computing device can be a personal computer, portable computer, a server, a router, a network computer, a peer device or other common network node, and so on. Logical connections between the computer 101 and a remote computing device 114a,b,c can be made via a local area network (LAN) and a general wide area network (WAN). Such network connections can be through a network adapter 108. A network adapter 108 can be implemented in both wired and wireless environments. Such networking environments are conventional and commonplace in offices, enterprise-wide computer networks, intranets, and the Internet 115.

For purposes of illustration, application programs and other executable program components such as the operating system 105 are illustrated herein as discrete blocks, although it is recognized that such programs and components reside at various times in different storage components of the computing device 101, and are executed by the data processor(s) of the computer. An implementation of training software 106 can be stored on or transmitted across some form of computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ Artificial Intelligence techniques such as machine learning and iterative learning. Examples of such techniques include, but are not limited to, expert systems, case based reasoning, Bayesian networks, behavior based Al, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

### II. EXEMPLARY TRAINING METHODS

### A. Generally

One of the most common hearing difficulties experienced is listening in noise. Localizing a sound source is also important, and the two skills can be related. To effectively listen in noise, individuals must be able to spatially segregate, localize, track sound, suppress information from one source to focus on another, and judge both movement and distance. None of this can be performed by simply wearing a hearing device. The ability to localize and understand speech-in-noise is influenced by spatial separation. Spatial separation of sound allows our auditory system to naturally ignore and “squelch” unnecessary sound.

There are two main cues that a human auditory system uses to recognize sounds and to separate them into different sound sources. These cues are timing and level differences between the two ears. Interaural timing differences (ITDs) and interaural level differences (ILDs) can be used to squelch competing sounds, attend to an ear with a better signal-to-noise ratio, locate the directionality of a sound, or analyze an auditory scene.

Sound does not have a physical dimension in space. Locating a sound source requires a neural computation by the auditory system. Binaural processing is one such computation that allows the auditory system to determine the location of sound in the horizontal or azimuth plane (the left-right dimension). This computation is based on the interaction of sound with the body (e.g., the head) of the listener and/or objects in the listener's environment. A sound source can be localized in space based upon the characteristics of the sound produced by the source. A sound source on one side of a listener will arrive at the ear closer to the source before it arrives at the ear farther from the source. This difference in arrival time is called interaural time difference (ITD). The level (loudness) of the sound at the ear nearer the source will also be greater than that at the ear farther from the source, generating an interaural level difference (ILD). The auditory system computes these two interaural differences (ITD and ILD), to determine the azimuthal location of the sound source. For example, if the ITD and the ILD are zero, then the source is directly in front of the listener, or at some point in the plane bisecting the body vertically. If the ITD and ILD are large, then the sound source's location is toward one ear or the other.

Speech-in-noise training involves speech perception where the speech and background noise originate from different loudspeakers. Table 1 lists the benefits of spatially separated speech-in-noise training.

TABLE 1

| Benefit | Description |
|---|---|
| Listening | Improvement in the recognition of sounds |
| Practice | Improvement in the sensitivity of softer sounds |
| | (e.g., consonant recognition), whispered speech, or |
| | speech at a distance. |
| Listening the in | Improvement in attending to relevant sounds |
| Presence of | while ignoring competing noise sources. |
| Noise | |
| Listening to | Improvement in spatial awareness of one's |
| Sounds from | acoustical environment. |
| Multiple Sound | Improvement of speech perception due to |
| Sources | squelching of noise. |

Localization training involves stimuli from different spatial locations. Table 2 lists the benefits of localization training.

TABLE 2

| Benefit | Description |
|---|---|
| Sense of | Improvement in following a moving sound |
| Motion | source. |
| Talker Location | Identification of a talker during a group |
| | conversation. |
| Safety | Improvement in spatial awareness of |
| | one's acoustic environment. |
| Auditory scene | Segregation of different sound sources in |
| | the environment. |
| Locating sound | Improvement in the ability to locate |
| sources out of | sounds behind you or in poor light conditions. |
| sight | |

i. Ignoring Unnecessary Sound

One advantage of normal hearing is having the opportunity to choose which signal to attend to. To accomplish this, the brain receives input from multiple signals coming from multiple locations and locks on to the sound with the better signal-to-noise ratio. In turn, the brain inhibits the input from the sound with the poorer signal to noise ratio. This task is accomplished by a brain mechanism that attends to the salient foreground information while monitoring the less clear background sound.

ii. Combining Information to “Squelch” Out Unnecessary Sound

In many realistic listening situations, either the target (usually speech) or background noise is closer to one ear than the other. The brain can combine the different information from each ear to improve performance by squelching out the unnecessary information. This is accomplished by neural interactions when either the noise or the signal is similar in both ears. It results in improved understanding and can be referred to as ‘squelching.’

Individuals with hearing loss have a difficult time naturally ignoring and “squelching” unnecessary sound. To train those individuals, the methods and systems provided are directed toward spatially separated speech-in-noise training and localization training. Both types of training can be provided separately, or at the same time (for example, in the same training module).

The methods and systems provided can utilize spatial distinctness by the use of multiple spatial sound locations, which allows individuals the opportunity to practice ignoring and “squelching” unwanted background sounds.

iii. Spatially Separate Stimuli

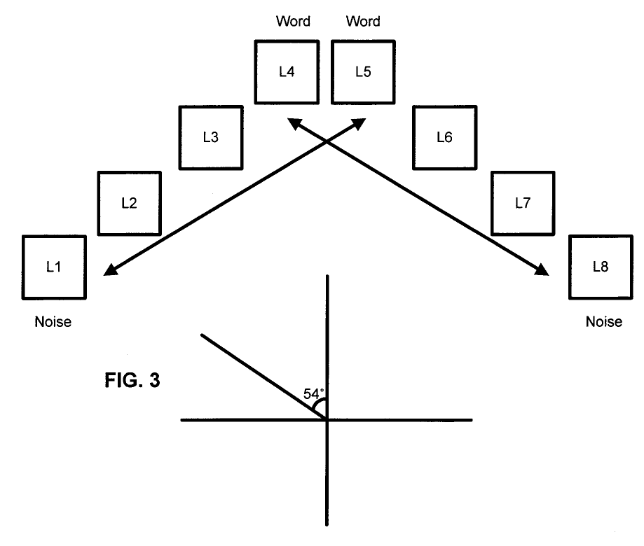

The methods and systems can use stimuli that are presented from different spatial locations, either physically or virtually. FIG. 3 provides a schematic of spatial separation of speech stimuli (e.g. a word) and noise. A target word or speech stimuli can be presented from the front and noise can be presented from one or more locations not in front of the user. The user can determine a specified amount of spatial separation between the target and the noise. For example, if the target is coming out of a location from the front, the listener can specify that the noise come out of a sound source 54° to the left or right. This distance can be manipulated by the user to make the spatial separation larger or smaller.

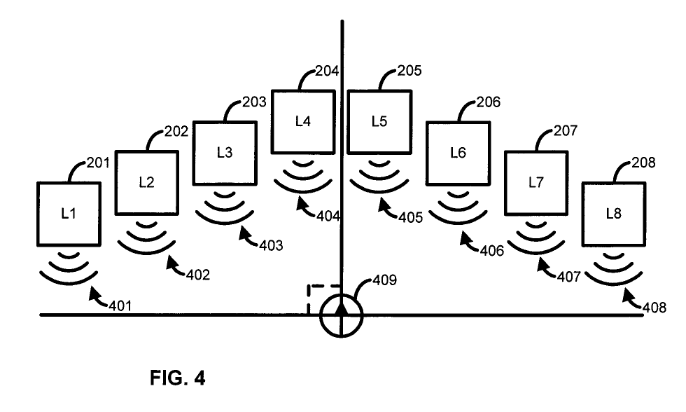

FIG. 4 illustrates stimuli 401-408 as presented from different spatial locations 201-208 relative to a student 409. The stimuli can be presented sequentially, or simultaneously. Different stimuli can be presented from different locations.

Examples of stimulus content include, but are not limited to speech, synthetic speech, noise, a sound effect, a tone, and music. Stimuli can be provided, for example, via loudspeakers, headphones, headphones configured to virtually simulate a plurality of spatial locations (i.e., head related transfer functions, either average or based on the individual student), hearing aids, cochlear implants, assistive listening devices, and the like. Noise can include noise encountered in an “everyday” environment (such as street noise), noise encountered in specialized environments (such as airplane cockpits), and the like. Speech stimulus content can include, but are not limited to real and nonsense phonemes, phrases, words, and sentences. Speech stimuli can be presented by real or synthetic male, female, child and cartoon voices.

iv. Visual and Audio Training

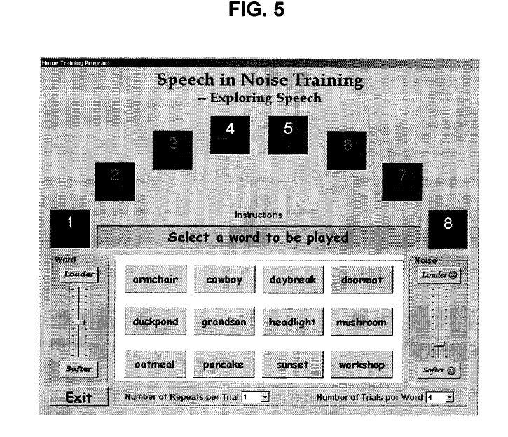

A listener can utilize a visual or tactile feedback system in conjunction with the audio system. The visual system can comprise screen (or similar display device) which can display a schematic of a user's listening scenario. For example, if a listener is training using eight loudspeakers (or eight virtual locations), then the screen can display eight loudspeakers in an arc (for example, but not limited to 108° arc). The listener can be provided a visual representation on the screen where the speech stimuli and the noise are coming from. This provides visual feedback to the listener. The listener can then concentrate on sounds coming from those physical or virtual locations. FIG. 5 illustrates an exemplary visual display.

### B. Training Techniques

The methods and systems can utilize several types of training techniques. For example, the methods and systems can utilize active exploring and guided learning. Active exploring allows students to control the type of stimuli they want to hear, the level of both the stimuli and background noise and the location of the target signal relative to the background noise. Students can compare and contrast sounds coming from different directions and correct and incorrect answers. Guided learning allows students to hear stimuli originate from pre-determined locations and to respond to either the type or location of the stimuli. Students then receive feedback as to the correctness of their response.

### C. Basic Method

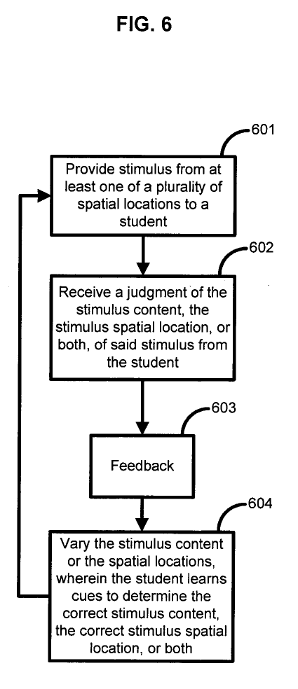

In one embodiment, illustrated in FIG. 6, provided are methods for improving hearing in noise and localization comprising (a) providing at least one stimulus having one of a plurality of stimulus content, wherein said stimulus originates from at least one of a plurality of spatial locations to a student at block 601, (b) receiving a judgment of the one of a plurality of stimulus content, the stimulus spatial location, or both, of said stimulus from the student at block 602, (c) providing feedback to the student regarding the correctness of the judgment at block 603, and (d) repeating steps a, b, and c, varying the at least one stimulus content or the at least one of the plurality of spatial locations, wherein the student learns cues to determine the correct stimulus content, the correct stimulus spatial location, or both at block 604.

Examples of stimulus content include, but are not limited to speech, noise, a sound effect, a tone, and music. Stimuli can be provided, for example, via loudspeakers, headphones, headphones configured to virtually simulate a plurality of spatial locations (i.e., head related transfer functions, either average or based on the individual student), hearing aids, cochlear implants, assistive listening devices, and the like.

The step of providing at least one stimulus can further comprise receiving a spatial location selection from which to provide the at least one stimulus.

The step of providing at least one stimulus can further comprise providing the at least one stimulus from a randomly selected spatial location. The step of repeating steps a, b, and c can further comprise providing the at least one stimulus from a spatial location a predetermined number of spatial locations from the randomly selected spatial location. The step of repeating steps a, b, and c can still further comprise adjusting the predetermined number of spatial locations wherein the predetermined number is increased if the student judgment is incorrect and the predetermined number is decreased if the student judgment is correct.

The at least one stimulus having one of a plurality of stimulus content can comprise a first stimulus content and a second stimulus content wherein the first stimulus content comprises speech content and the second stimulus content comprises noise content.

### B. Specific Embodiments

i. Localization Training—Active Exploring

In another aspect, provided are training methods for improving spatial hearing comprising receiving a sound spatial location selection from a user; generating a sound from the selected spatial location wherein the user hears the sound and associating, by the user, the spatial location with the sound heard wherein the user learns the direction of the sound. The steps can be repeated several times with multiple spatial locations and multiple sound stimuli wherein the user learns processing cues to determine the difference between the multiple spatial locations.

ii. Localization Training—Guided Learning

In still another aspect, provided are training methods for improving spatial hearing comprising generating a sound from a random spatial location wherein a user hears the sound, receiving a spatial location identification from the user, determining if the spatial location identified by the user is correct, providing feedback to the user as to the identification of the random spatial location by generating sound from the correct spatial location and generating sound from the user selected spatial location, and associating, by the user, the location of the correct spatial location and comparing it to the user selected spatial location wherein the user learns the difference in processing cues for the correct spatial location and user selected spatial location to determine the direction of the sound.

The training steps can be repeated several times utilizing the random presentation wherein the user learns processing cues to determine the difference between the multiple spatial locations.

iii. Speech-in-Noise Training—Active Exploring—Exploring Speech

In a further aspect, provided are training methods for improving spatial hearing comprising receiving a selection of a speech stimulus from a user, generating the speech stimulus from a source located in front of the user wherein a user hears the speech stimulus, generating a noise from a source located at a predetermined number of sources away from the speech stimulus source wherein a user hears the noise, and associating, by the user, the speech stimulus sound with speech and the noise sound with noise.

The predetermined number of sources can be altered by the user to increase or decrease difficulty. The intensity of the speech stimulus and noise can be manipulated by the user to vary the level of difficulty in segregating the speech and noise. The training steps can be repeated several times with multiple speech stimuli wherein the user learns processing cues to segregate the speech and noise.

iv. Speech-in-Noise Training—Active Exploring—Exploring Noise Direction

In another aspect, provided are training methods for improving spatial hearing comprising receiving a location of a noise source from a user, generating a noise from the selected source location wherein the user hears the noise, generating a random speech stimulus from a source located in front of the user wherein a user sees and hears the speech stimulus, associating, by the user, the speech stimulus sound with speech and the noise sound with noise.

The intensity of the speech stimulus and noise can be manipulated by the user to vary the level of difficulty in segregating the speech and noise. The training steps can be repeated several times with multiple speech stimuli wherein the user learns processing cues to segregate the speech and noise.

v. Speech-in-Noise Training—Guided Learning—Fixed Noise Location

In yet another aspect, provided are training methods for improving spatial hearing comprising generating a random speech stimulus from a source located in front of the user wherein a user hears the speech stimulus, generating a noise from a source located at a predetermined number of sources away from the speech stimulus source wherein a user hears the noise, receiving a speech stimulus source identification from the user, determining if the speech stimulus source identified by the user is the random source, providing feedback to the user as to the identification of the random source by generating sound from the correct speech stimuli and generating sound from the user selected speech stimuli wherein a user sees and hears the speech contrast associating, by the user, the correct versus incorrect speech stimuli respect to the location of the noise source wherein the user takes advantage of the spatial separation of the speech and noise.

The predetermined number of sources can be altered by the user to increase or decrease difficulty. The intensity of speech stimulus and noise source can be manipulated by the user to vary the level of difficulty in segregating the speech and noise. The training steps can be repeated several times with multiple speech stimuli wherein the user learns processing cues to segregate the speech and noise.

vi. Speech-in-Noise Training—Guided Learning—Random Noise Location

In another aspect, provided are training methods for improving spatial hearing comprising generating a speech stimulus from a random source wherein the user hears the speech stimulus, generating a noise from a random location wherein the user hears the noise, receiving a speech stimulus source identification from the user, determining if the speech stimulus source identified by the user is the random source, providing feedback to the user as to the identification of the random source by generating sound from the correct speech stimuli and generating sound from the user selected speech stimuli wherein a user sees and hears the speech contrast associating, by the user, the correct versus incorrect speech stimuli respect to the location of the noise source wherein the user takes advantage of the spatial separation of the speech and noise.

The random sources can be alternated to increase or decrease difficulty. Intensity of speech stimulus and noise source can be manipulated by the user to vary the level of difficulty in segregating the speech and noise. The training steps can be repeated several times with multiple speech stimuli wherein the user learns processing cues to segregate the speech and noise.

vii. Exemplary Training Session

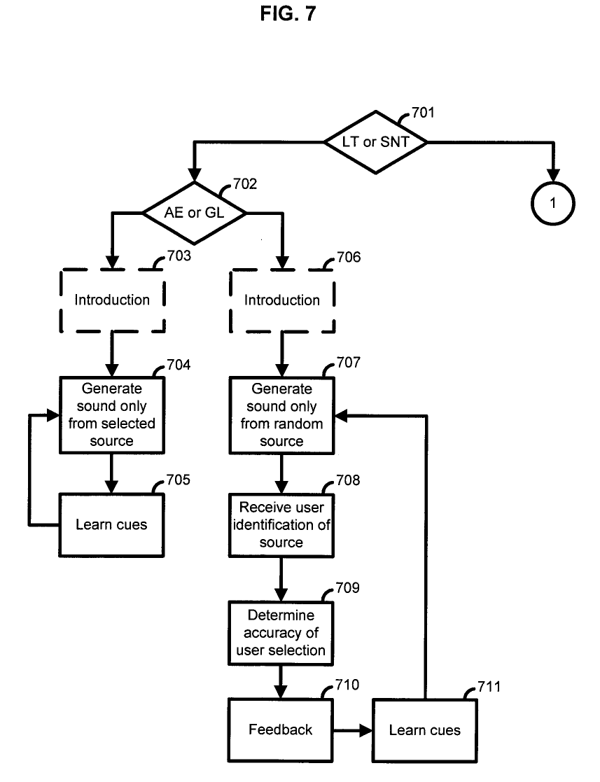

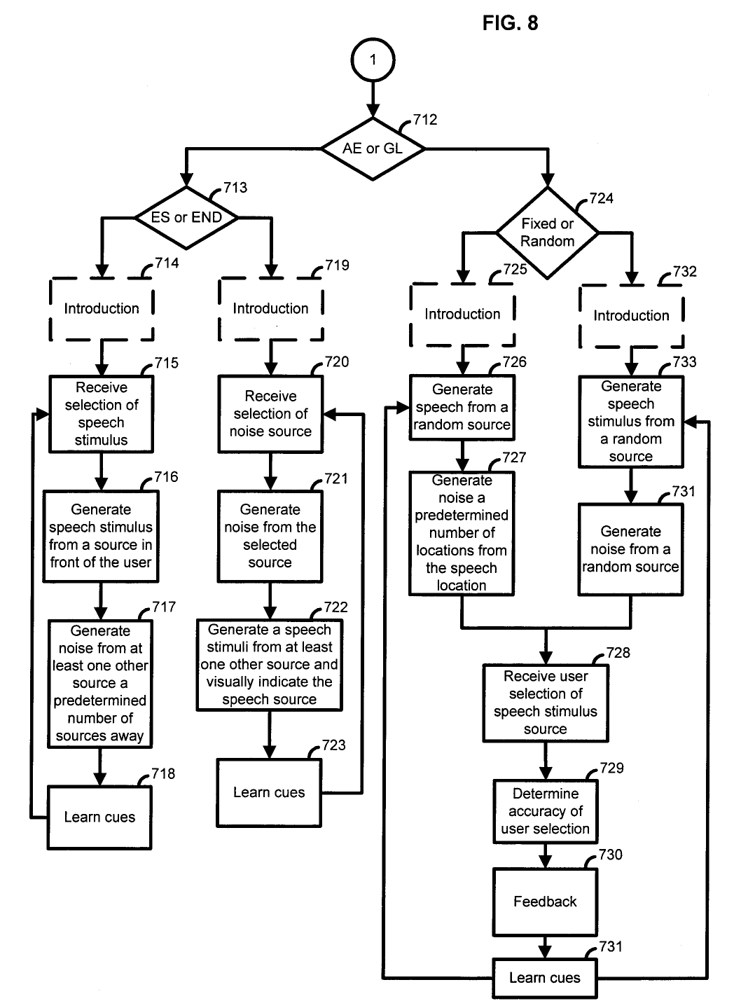

FIG. 7 and FIG. 8 illustrate an exemplary training program comprised of six training modules. Beginning with block 701, a user can choose whether to undergo Localization Training or Speech-in-Noise training. If the user selects Localization Training, the user can select, at block 702, to train using Active Exploring or Guided Learning. If at block 702, the user selects Active Exploring, the user can receive an optional introduction at block 703. The optional introduction explains how the training session will proceed and what the user should expect. Then, at block 704, the system generates a stimulus sound from a user selected spatial location. The user can knows the spatial location of the stimulus, hears the stimulus content, and, at block 705, learns cues to determine the correct stimulus content, the correct stimulus spatial location, or both. The system can return to block 704, to continue training and allow the user to explore stimuli coming from various spatial locations. The user can reuse the same stimulus or can use a randomly selected stimulus. The user can adjust the sound level, the user can specify the number of repeats per trial and the number of trials per spatial location, and the user can select the difficulty level.

If, at block 702, the user selects Guided Learning, the user can be presented with an optional introduction at block 706. Then the system can generate a stimulus sound from a randomly selected spatial location at block 707. The system can receive a user identification of a spatial location that the user believes generated the sound at block 708. At block 709, the system can determine the accuracy of the user identification and provide feedback to the user at block 710. At block 711, based on the feedback, the user learns cues to determine the correct stimulus content, the correct stimulus spatial location, or both. The system can return to block 707, to continue training. The user can reuse the same stimulus or can use a randomly selected stimulus. The user can adjust the sound level, the user can specify the number of repeats for comparison and the number of trials expected, and the user can select the difficulty level.

Returning to block 701, if the user selects Speech-in-Noise training, the system proceeds to FIG. 8, block 712. At block 712, the user can select whether to train using Active Exploring or Guided Learning. If at block 712, the user selects Active Exploring, the user can select whether to train in Exploring Speech or in Exploring Noise Direction at block 713. If the user selects Exploring Speech, the user can be presented with an optional introduction at block 714. Then, at block 715, the system receives a user selection of a speech stimulus. At block 716, the system generates the speech stimulus sound from a spatial location in front of the user. For example, the spatial location can be from about 30° to about 90° to either side of the user. For example, the spatial location can be 54° to either side of the user. While the system is generating the speech stimulus sound, noise can be generated from at least one spatial location a predetermined number of spatial locations from the spatial location of the speech stimulus sound at block 717. The predetermined number can be, for example, one, two, three, four, five, six, seven, eight, or nine spatial locations either to the left or right separating the speech stimulus sound and the noise stimulus sound. For example, the predetermined number can be four. Then, at block 718, the user learns cues to determine the correct stimulus content, the correct stimulus spatial location, or both. The system can return to block 715, to continue training. The user can choose whatever words (speech) the user wants to listen to, the user can adjust the word/noise level, and the user can specify the number of repeats per trial, and the number of trials per word.

If, at block 713, the user selects Exploring Noise Direction, the user can be presented with an optional introduction at block 719. Then the system can receive a selection of a noise spatial location at block 720. The system can generate the noise from the selected spatial location at block 721. While the noise is being generated, the system can generate a speech stimulus from at least one other spatial location and indicate the at least one other spatial location on a display device to the user at block 722. Then, at block 723, the user learns cues to determine the correct stimulus content, the correct stimulus spatial location, or both. The system can return to block 720, to continue training. The user can choose the spatial location that the user wants the noise to come from, the user can adjust word/noise level, the user can specify the number of repeats per trial, and the number of trials per spatial location.

Returning to block 712, if the user selects Guided Learning, the user can select whether to undergo Fixed training or Random training at block 724. If the user selects Fixed training, the user can be presented with an optional introduction at block 725. The system can then generate a speech stimulus from a randomly selected spatial location at block 726. Concurrently, the system, at block 727, generates noise a predetermined number of spatial locations from the spatial location of the speech stimulus. The predetermined number can be, for example, one, two, three, four, five, six, seven, eight, or nine spatial locations either to the left or right separating the speech stimulus sound and the noise stimulus sound. For example, the predetermined number can be four. Then, at block 728, the system can receive a selection by the user of the spatial location the user believes to be generating the speech stimulus. The system can determine the accuracy of the user selection at block 729 and provide feedback to the user at block 730. At block 731, the user learns cues to determine the correct stimulus content, the correct stimulus spatial location, or both. The system can return to block 726, to continue training. The user can adjust the word/noise level and the user can specify the number of repeats for comparison, and the total number of trials expected.

If at block 724, the user selects Random training, the system can provide the user with an optional introduction at block 732. The system can then generate a speech stimulus from a randomly selected spatial location at block 733. Concurrently, at block 734, the system can generate noise from a randomly selected spatial location other that the speech location. Then, at block 728, the system can receive a selection by the user of the spatial location the user believes to be generating the speech stimulus. The system can determine the accuracy of the user selection at block 729 and provide feedback to the user at block 730. At block 731, the user learns cues to determine the correct stimulus content, the correct stimulus spatial location, or both. The system can return to block 733, to continue training. The user can adjust the word/noise level and the user can specify the number of repeats for comparison, and the total number of trials expected.

### III. EXAMPLE

The following example is put forth so as to provide those of ordinary skill in the art with a complete disclosure and description of how the systems and methods claimed herein are made and evaluated, and are intended to be purely exemplary of the methods and systems and are not intended to limit the scope. Efforts have been made to ensure accuracy with respect to numbers, but some errors and deviations should be accounted for.

The methods and systems were used to train three adult bilateral cochlear implant (CI) recipients. All of these individuals had at least three years of experience with their cochlear implants at the time of training

A. Compliance

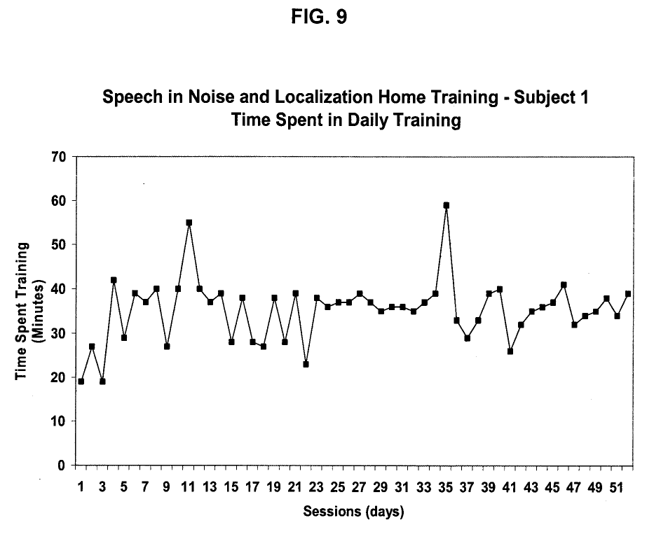

There was a concern as to whether individuals would be motivated to use a home-based training system that requires daily practice and basic computer skills. Hearing impaired adults often rely on a computer as a form of communication (i.e., email). FIG. 9 shows a daily log of how much time one individual practiced with the system. This individual took the system home for approximately two months and practiced for at least thirty minutes each day.

B. Speech-in-Noise Data

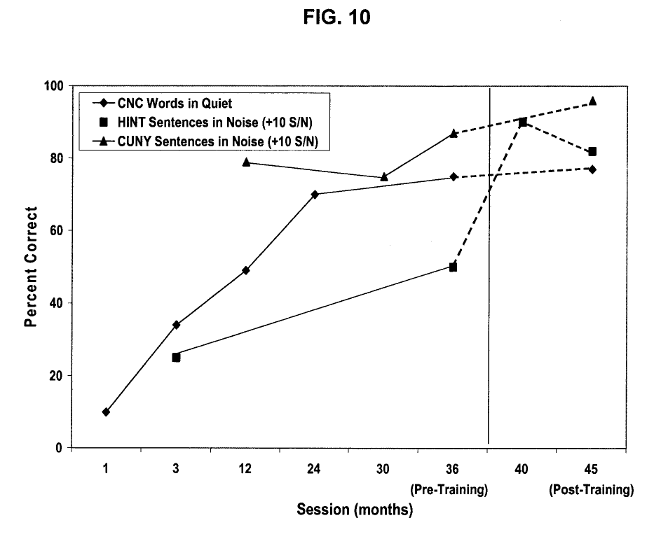

Pre-training baseline speech perception in noise and localization was collected data. FIG. 10 shows general speech perception data collected over time and pre-and post-training for words in quiet (Consonant-Nucleus-Consonant or CNC Words) and sentences in noise (both the Hearing-In-Noise Test and the City University Sentences). Results show that scores gradually improved overtime for HINT sentences and CNC word scores with 50% improvement post-training on the HINT sentences. The CNC word scores did not show a significant improvement post-training while the CUNY sentences showed an improvement of about 10%. The CUNY sentence score post-training was confined, however, by a ceiling effect. It should be noted, that none of the stimuli presented during the tests were used as part of the training modules. Thus the test stimuli were independent of the training stimuli.

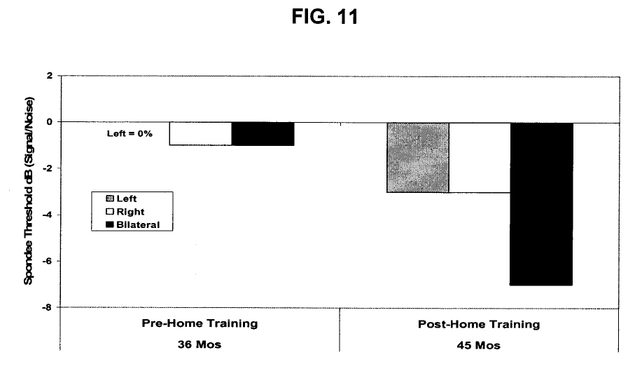

Results from an adaptive spondee in noise test (Adaptive SRT) are shown in FIG. 11. This test contains the same stimuli from which the individual trained on. Results show the signal-to-noise ratio required for this individual to obtain a 50% correct score. Significant improvements are shown with the right CI only, left CI only and bilateral CIs after home training.

C. Localization Data

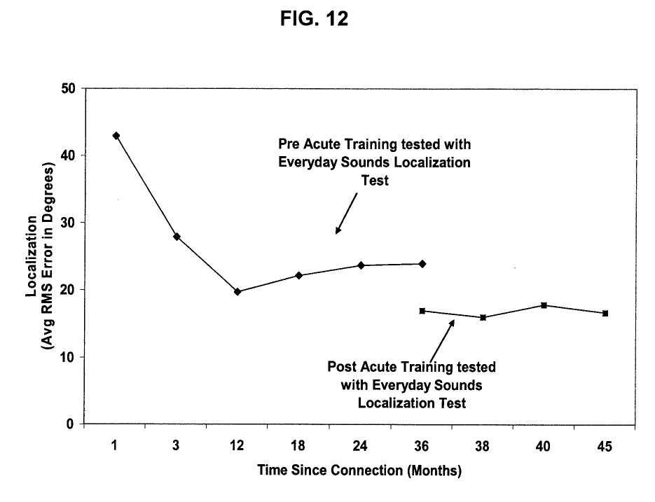

FIG. 12 shows overtime and post-training localization performance collected from the same bilateral CI patient as shown in FIGS. 9-11. Localization performance is represented by a root mean square error in degrees (the lower the number, the better the performance). At 36 months post-implantation, the individual was trained acutely twice a day for two consecutive days. This individual showed a significant improvement in localization ability post-laboratory training. The individual continued training at home for approximately two months. This individual was re-tested at 38 and 40 months post-implantation and while no improvement was shown in performance, the significant improvement shown after acute laboratory training remained consistent.

While the methods and systems have been described in connection with preferred embodiments and specific examples, it is not intended that the scope of the methods and systems be limited to the particular embodiments set forth, as the embodiments herein are intended in all respects to be illustrative rather than restrictive.

Unless otherwise expressly stated, it is in no way intended that any methods set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made in the present methods and systems without departing from the scope or spirit of the methods and systems. Other embodiments of the methods and systems will be apparent to those skilled in the art from consideration of the specification and practice of the methods and systems disclosed herein. It is intended that the specification and examples be considered as exemplary only, with a true scope and spirit of the methods and systems being indicated by the following claims.

What is claimed is:

1. A method for improving hearing in noise and localization comprising:
a. providing at least one stimulus having one of a plurality of stimulus content, wherein said stimulus originates from at least one of a plurality of spatial locations to a student;
b. receiving a judgment of the one of a plurality of stimulus content, the stimulus spatial location, or both, of said stimulus from the student;
c. providing feedback to the student regarding the correctness of the judgment; and
d. repeating steps a, b, and c, varying the at least one stimulus content or the at least one of the plurality of spatial locations, wherein the student learns cues to determine the correct stimulus content, the correct stimulus spatial location, or both.

2. The method of claim 1, wherein the at least one stimulus is provided via a loudspeaker.

3. The method of claim 1, wherein spatial locations are simulated virtually.

4. The method of claim 1, wherein providing at least one stimulus further comprises:
receiving a spatial location selection from which to provide the at least one stimulus.

5. The method of claim 1, wherein providing at least one stimulus further comprises:
providing the at least one stimulus from a randomly selected spatial location.

6. The method of claim 5, wherein repeating steps a, b, and c further comprises:
providing the at least one stimulus from a spatial location a predetermined number of spatial locations from the randomly selected spatial location.

7. The method of claim 6, wherein repeating steps a, b, and c further comprises:
adjusting the predetermined number of spatial locations wherein the predetermined number is increased if the student judgment is incorrect and the predetermined number is decreased if the student judgment is correct.

8. The method of claim 1, wherein the one of a plurality of stimulus content is selected from the group consisting of:
speech;
noise;
a sound effect;
a tone; and
music.

9. The method of claim 1, wherein the at least one stimulus having one of a plurality of stimulus content comprises a first stimulus content and a second stimulus content wherein the first stimulus content comprises speech content and the second stimulus content comprises noise content.

10. A system for improving hearing in noise and localization comprising:
a plurality of spatial locations configured to originate a stimulus;
a memory, configured for storing a plurality of stimuli; and
a processor, coupled to the memory and the plurality of spatial locations, configured for performing the steps of:
a. providing at least one stimulus having one of a plurality of stimulus content, wherein said stimulus originates from at least one of a plurality of spatial locations to a student;
b. receiving a judgment of the one of a plurality of stimulus content, the stimulus spatial location, or both, of said stimulus from the student;
c. providing feedback to the student regarding the correctness of the judgment; and
d. repeating steps a, b, and c, varying the at least one stimulus content or the at least one of the plurality of spatial locations, wherein the student learns cues to determine the correct stimulus content, the correct stimulus spatial location, or both.

11. The system of claim 10, wherein the plurality of spatial locations is selected from the group consisting of:
a plurality of loudspeakers; and
a set of headphones configured to virtually simulate a plurality of spatial locations.

12. The system of claim 10, wherein providing at least one stimulus further comprises:
receiving a spatial location selection from which to provide the at least one stimulus.

13. The system of claim 10, wherein providing at least one stimulus further comprises:
providing the at least one stimulus from a randomly selected spatial location.

14. The system of claim 13, wherein repeating steps a, b, and c further comprises:
providing the at least one stimulus from a spatial location a predetermined number of spatial locations from the randomly selected spatial location.

15. The system of claim 14, wherein repeating steps a, b, and c further comprises:
adjusting the predetermined number of spatial locations wherein the predetermined number is increased if the student judgment is incorrect and the predetermined number is decreased if the student judgment is correct

16. The system of claim 10, wherein the one of a plurality of stimulus content is selected from the group consisting of:
speech;
noise;
a sound effect;
a tone; and
music.

17. The system of claim 10, wherein the at least one stimulus having one of a plurality of stimulus content comprises a first stimulus content and a second stimulus content wherein the first stimulus content comprises speech content and the second stimulus content comprises noise content.

18. A computer readable medium with computer executable instructions embodied thereon for improving hearing in noise and localization comprising:
a. providing at least one stimulus having one of a plurality of stimulus content, wherein said stimulus originates from at least one of a plurality of spatial locations to a student;
b. receiving a judgment of the one of a plurality of stimulus content, the stimulus spatial location, or both, of said stimulus from the student;
c. providing feedback to the student regarding the correctness of the judgment; and
d. repeating steps a, b, and c, varying the at least one stimulus content or the at least one of the plurality of spatial locations, wherein the student learns cues to determine the correct stimulus content, the correct stimulus spatial location, or both.

19. The computer readable medium of claim 18, wherein the one of a plurality of stimulus content is selected from the group consisting of:
speech;
noise;
a sound effect;
a tone; and
music.

20. The computer readable medium of claim 1, wherein the at least one stimulus having one of a plurality of stimulus content comprises a first stimulus content and a second stimulus content wherein the first stimulus content comprises speech content and the second stimulus content comprises noise content.
